(19) United States
(12) Patent Application Publication
(10) Pub. No.: US 2016/0335546 A1
(43) Pub. Date: Nov. 17, 2016

(54) SELF-PIPELINING WORKFLOW MANAGEMENT SYSTEM

(71) Applicant: Sidra Medical and Research Center, Doha (QA)

(72) Inventor: Andrey Ptitsyn, Doha (QA)

(21) Appl. No.: 14/712,648

(22) Filed: May 14, 2015

(51) Int. Cl. G06N 5/04; G06N 99/00

(52) U.S. Cl. CPC G06N 5/04; G06N 99/005

(57) ABSTRACT

The specification relates to a self-pipelining workflow management system. The system can receive a request to run a bioinformatics analysis and automatically create a workflow by accessing a knowledge structure. The knowledge structure can include a plurality of predicates describing computational relationships between at least one bioinformatics data file and at least two bioinformatics programs. The workflow contains a dynamic set of predicates specific to the request based upon initial input data, general request parameters and the knowledge structure. The workflow is initiated based on a first predicate of the dynamic set of predicates and after a new unprocessed input data is obtained, the dynamic set of predicates is updated. The workflow continues until no more predicates can be associated with the unprocessed input data or no more unprocessed data can be obtained.

### BACKGROUND

The subject matter described herein relates to a self-pipelining workflow management system.

The sequencing of DNA and RNA molecules has undergone dramatic change in the past few decades and its use is exponentially growing. Sequencing techniques need to keep current with rapid and accurate computer analysis of these biological sequences. The omics (e.g., genomics, proteomics, and metabolomics) software arsenal includes algorithms for pattern search, alignment, functional site recognition and many others. Most of the implementations of these algorithms are accumulated in program packages, e.g., open-source, web-based platforms for data-intensive biomedical and genetic research available as a “cloud computing” resource but the program packages may also run on grids, clusters or standalone workstations alike.

“Cloud computing” is a network of powerful computers that can be remotely accessed no matter where the user is located. The “cloud” shifts the workload of software storage, data storage, and hardware infrastructure to a remote location of networked computers allowing a user to harness the power of the “cloud.” These platforms help scientists and biomedical researchers harness sequencing and analysis software, as well as, provide storage capacity for large quantities of scientific data.

These platforms also pull together a variety of tools that allow for easy retrieval and analysis of large amounts of data, simplifying the process of -omic analyses. This is accomplished by combining the power of existing -omic-annotation databases with a web portal to enable users to search remote resources, combine data from independent queries, and visualize the results. These platforms also allow other researchers to review the steps that have previously been taken by creating a public report of analyses so, after a paper has been published, scientists in other labs can attempt to reproduce the results described.

### SUMMARY

The disclosed technology relates to a self-pipelining workflow management system. The system can receive a request to run an analysis, e.g., a bioinformatics analysis and automatically create a workflow by accessing a knowledge structure. The knowledge structure can include a plurality of predicates describing computational relationships between bioinformatics data files and bioinformatics programs. The workflow contains a dynamic set of predicates specific to the request based upon a source of initial input data, general request parameters and the knowledge structure. The workflow is initiated based on a first predicate of the dynamic set of predicates and after a new, unprocessed input data is obtained from an output of a bioinformatics programs, the dynamic set of predicates is updated. The workflow continues until no more predicates can be associated with the unprocessed input data or no more unprocessed data can be obtained.

For example, the disclosed technology can perform bioinformatics analyses through the use of a self-pipelining, logical programming platform. This platform includes a knowledge structure that includes predicates for computational relationships between bioinformatics data files and bioinformatics programs within a given bioinformatics system. When a user requests to run a specific analysis, the disclosed technology accesses the knowledge structure and, based upon methods and parameters defined in the request, automatically decides the order in which bioinformatics programs specific to that request are executed. The order of execution is dynamic and can change during the execution process, based on intermediate results. The execution can continue until the system of programs and data reaches a state of equilibrium, i.e., when no more data can be associated with programs, no more new results can be produced by the programs, or no more predicates apply to the analysis according to the knowledge base.

In one implementation, the methods comprise the steps of: a) receiving a request to run a bioinformatics analysis, the request defining a source for initial input data and general request parameters; b) accessing a knowledge structure stored in a database, the knowledge structure including a plurality of predicates describing computational relationships between at least one bioinformatics data file and at least two bioinformatics programs; c) forming a dynamic set of predicates specific to the request based upon the initial input data, the general request parameters and the plurality of predicates of the knowledge structure; d) initiating at least one of the at least two bioinformatics programs based on a first predicate of the dynamic set of predicates, the initial input data being available at the time of execution for the at least one of the at least two bioinformatics programs; e) obtaining a new unprocessed input data from the at least one of the at least two bioinformatics programs; f) updating the dynamic set of predicates based upon the upon the new unprocessed input data, the general request parameters and the plurality of predicates of the knowledge structure; g) initiating at least one more of the at least two bioinformatics programs based on a predicate of the updated set of predicates, the new unprocessed input data being available at the time of execution for the at least one more of the at least two bioinformatics programs; and h) repeating the method from step e) until no more predicates can be associated with the unprocessed input data or no more unprocessed data can be obtained.

In some implementations, the method can further comprise the steps of: obtaining a resultant for the bioinformatics analysis. In some implementations, the general request parameters can include a desired set of methods and available resources needed to obtain the resultant for the bioinformatics analysis. In some implementations, the method can further comprise the steps of: automatically deciding an order of execution for the dynamic set of predicates based upon the desired set of methods and the available resources defined in the general request parameters. In some implementations, the order of execution for the dynamic set of predicates can change during an execution process based on intermediate results. In some implementations, the method can further comprise the steps of: building a mapping table based upon the order of execution for the dynamic set of predicates needed to fulfill the request, the mapping table guiding starts and stops of the bioinformatics programs. In some implementations, the bioinformatics programs can be started consecutively, in parallel or a combination of both. In some implementations, the execution process can continue until the programs and data reaches a state of equilibrium.

In another implementation, a system can comprise one or more processors and one or more computer-readable storage mediums containing instructions configured to cause the one or more processors to perform operations. The operations can include: a) receiving a request to run a bioinformatics analysis, the request defining a source for initial input data and general request parameters; b) accessing a knowledge structure stored in a database, the knowledge structure including a plurality of predicates describing computational relationships between at least one bioinformatics data file and at least two bioinformatics programs; c) forming a dynamic set of predicates specific to the request based upon the initial input data, the general request parameters and the plurality of predicates of the knowledge structure; d) initiating at least one of the at least two bioinformatics programs based on a first predicate of the dynamic set of predicates, the initial input data being available at the time of execution for the at least one of the at least two bioinformatics programs; e) obtaining a new unprocessed input data from the at least one of the at least two bioinformatics programs; f) updating the dynamic set of predicates based upon the upon the new unprocessed input data, the general request parameters and the plurality of predicates of the knowledge structure; g) initiating at least one more of the at least two bioinformatics programs based on a predicate of the updated set of predicates, the new unprocessed input data being available at the time of execution for the at least one more of the at least two bioinformatics programs; and h) repeating the method from step e) until no more predicates can be associated with the unprocessed input data or no more unprocessed data can be obtained.

In another implementation, a computer-program product can be tangibly embodied in a machine-readable storage medium and include instructions configured to cause a data processing apparatus to: a) receive a request to run a bioinformatics analysis, the request defining a source for initial input data and general request parameters; b) access a knowledge structure stored in a database, the knowledge structure including a plurality of predicates describing computational relationships between at least one bioinformatics data file and at least two bioinformatics programs; c) form a dynamic set of predicates specific to the request based upon the initial input data, the general request parameters and the plurality of predicates of the knowledge structure; d) initiate at least one of the at least two bioinformatics programs based on a first predicate of the dynamic set of predicates, the initial input data being available at the time of execution for the at least one of the at least two bioinformatics programs; e) obtain a new unprocessed input data from the at least one of the at least two bioinformatics programs; f) update the dynamic set of predicates based upon the upon the new unprocessed input data, the general request parameters and the plurality of predicates of the knowledge structure; g) initiate at least one more of the at least two bioinformatics programs based on a predicate of the updated set of predicates, the new unprocessed input data being available at the time of execution for the at least one more of the at least two bioinformatics programs; and h) repeat the method from step e) until no more predicates can be associated with the unprocessed input data or no more unprocessed data can be obtained.

The advantage of the disclosed technology is that it allows for fast automatic analysis as well as interactive parameters for selected programs.

### BRIEF DESCRIPTION OF THE DRAWINGS

FIG. 1 is a flow chart showing an example process of the disclosed technology;

FIG. 2a-b is a flow chart showing an example process of the disclosed technology;

FIG. 3 is a flow chart showing an example process of the disclosed technology; and

FIG. 4 is a block diagram of an example of a system used with the disclosed technology.

### DETAILED DESCRIPTION

The disclosed technology relates to a self-pipelining workflow management system. The system can receive a request to run a bioinformatics analysis and automatically create a workflow by accessing a knowledge structure. The knowledge structure can include a plurality of predicates describing computational relationships between bioinformatics data files and bioinformatics programs. The workflow contains a dynamic set of predicates specific to the request based upon a source of initial input data, general request parameters and the knowledge structure. The workflow is initiated based on a first “true”, positive predicate of the dynamic set of predicates and after a new unprocessed input data is obtained from an output of a bioinformatics program, the dynamic set of predicates is updated. The workflow continues until no more predicates can be associated with the unprocessed input data or no more unprocessed data can be obtained.

Researchers are interested in processing a DNA sequence involving as many methods as possible for capturing sequence details. But these researchers also have a special interest with particular methods, e.g., coding regions recognition, and therefore seek to have the most accurate results possible in the field they are working. Working with conventional program packages researchers usually have to be experienced in computer programming to get the good results for their special interest by manipulating program algorithms or at least understand the meaning of parameters and how they relate to the algorithms. For example, in the case of mass sequencing, it can be extremely difficult to obtain the parameters for each sequence to obtain an overall pattern.

Scientific workflow systems have been added to conventional program packages to build multi-step computational analyses and provide a graphical user interface for specifying on what data to operate, what steps to take, and in what order to do them. These workflow systems enable researchers to do their own custom reformatting and manipulation without having to do any programming. A bioinformatics workflow management system is a specialized form of workflow management system designed specifically to compose and execute a series of computational or data manipulation steps that relate to bioinformatics. There are currently many different workflow systems. These systems allow researchers access to computational analysis without requiring them to understand computer programming by offering a simple user interface over the ability to build complex workflows. These systems can be based on an abstract representation of how a computation proceeds in the form of a directed graph, where each node represents a task to be executed and edges represent either data flow or execution dependencies between different tasks. Each system typically allows the user to build and modify complex applications with little or no programming expertise.

These systems make it relatively easy to build simple analyses, but more difficult to build complex workflows that include, for example, looping constructs. These complex workflows cannot be done by human analysis alone due to the complexity of the analyses. If a researcher wants to run a complex workflow, the researcher still must have knowledge of computer programming to form these complex workflows. As a computer environment is needed to form the complex workflow.

In order to overcome this problem, the disclosed technology integrates programs based on an organization of predicates for all computational relationships between bioinformatics data files and bioinformatics programs within a given bioinformatics system. The organization of predicates translates into a knowledge structure that forms the basis of a self-pipelining, logical programming platform. The knowledge structure is stored in a database. Now, when a job is submitted to the system, a workflow can be automatically and dynamically generated by accessing database storing the knowledge structure.

In one implementation, a request for a bioinformatics analysis can be separated into two parts. The first part represents a desired analysis or biological task and the second part represents the managing of the task within the computer network. This separation provides flexibility when changing the parameters of the analysis as well as updating or adding application programs needed for the analysis.

The analysis is an upper-level process driven by a workflow created using the workflow management system. The upper-level process treats each step of the workflow, e.g., each execution of an application programs, like a “black box”. For example, data is input into an application program and an output is received on the other side. The procedure of analysis consists of sequential work of such “black boxes”, associated with single steps of analysis. The upper-level process main functions are: sequential execution of the steps of analysis according to workflow, results storage in temporary data base, and final data presentation. This upper-level process can be driven by a subsystem called the “project manager.”

The management side is a lower-level process that takes care of the application programs. The lower-level process controls execution of the application programs, the data input, the data output, the results presentation and more. This lower-level process performs the following functions: interacts with upper-level process, provides user interface for research programs, and runs and controls the research programs.

The disclosed technology can be equipped with different sets of application programs. For example, sequence analysis uses a variety of programs, such as QCRef, CountReads, PrintReads, etc. in GATK package, to obtain its analyses. These programs usually implement algorithms related to some type of analysis, for instance, BoWTie, BWA and BWA MEM implement variations of sequence alignment based on Barrows-Wheeler transformation algorithm. These algorithms can be written in any programming language and allows a programmer to choose how to make the program most effectively. A programmer writes the program keeping within certain guidelines, e.g., using standard formats and names for input and output files, etc. In some implementations, all data input and output can be reduced to standard named files of standard format and all data is transmitted by or temporally stored in files of standard formats. The programmer also has to write a task-definition file, describing how to run the program. For each set of programs, a graphic interface can be provided along with access to data storage, data interchange and data presentation modules.

In a conventional system, analysis of a new sequence starts with the organization of a new project. First a user fills out a request, e.g., a simple form, on a display screen. The user can name the project, point to a file containing initial data, and decide the type of analyses to run, comment on the project and so on. The user then sets up a workflow by clicking with a mouse or keyboard methods of interest or the user can switch to the manual regime to vary the parameters.

After the request is completed, the project can be started and the programs can be executed in the order described in the workflow. Once started, the project manager picks up the next step pointed in the work plan, checks to see if the data files for this step are available, transfers these files to the directory of the application program and initiates the so called low-level process.

After the low-level process finishes, the project manager confirms the presence of the result files, transfers them to the project directory and passes to the next step. Project execution can be interrupted and postponed projects can be loaded to be resumed. After the project if finished (or interrupted) the user can have information about the project itself and the results of the steps taken.

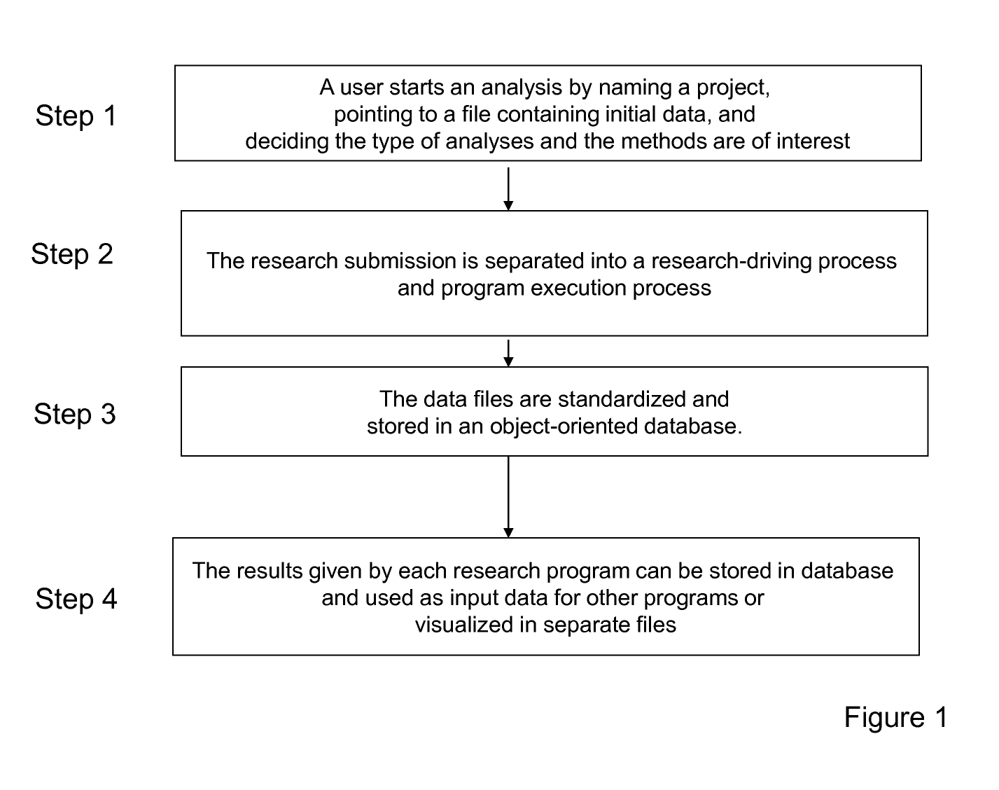

In one implementation of the disclosed technology, as shown in FIG. 1, a user starts an analysis by naming a project, pointing to a file containing initial data, and deciding the type of analyses and the methods that are of interest. (Step 1) All other variables of analysis run in an automatic regime and do not need any attention. This considerably speeds up operations. For example, if the scenario includes a long workflow, e.g., database homology search, the workflow is automatically created thereby increasing speed and efficiency.

The research submission can be separated into a research-driving process (i.e. high-level process) and program execution process (i.e., low-level process). (Step 2). The data files can be standardized into a few types and stored in an object-oriented database. (Step 3). The results given by each research program can be stored in database and used as input data for other programs or visualized in separate files being interpreted before the program starts. (Step 4). This makes the disclosed technology flexible and open to absorb new application programs.

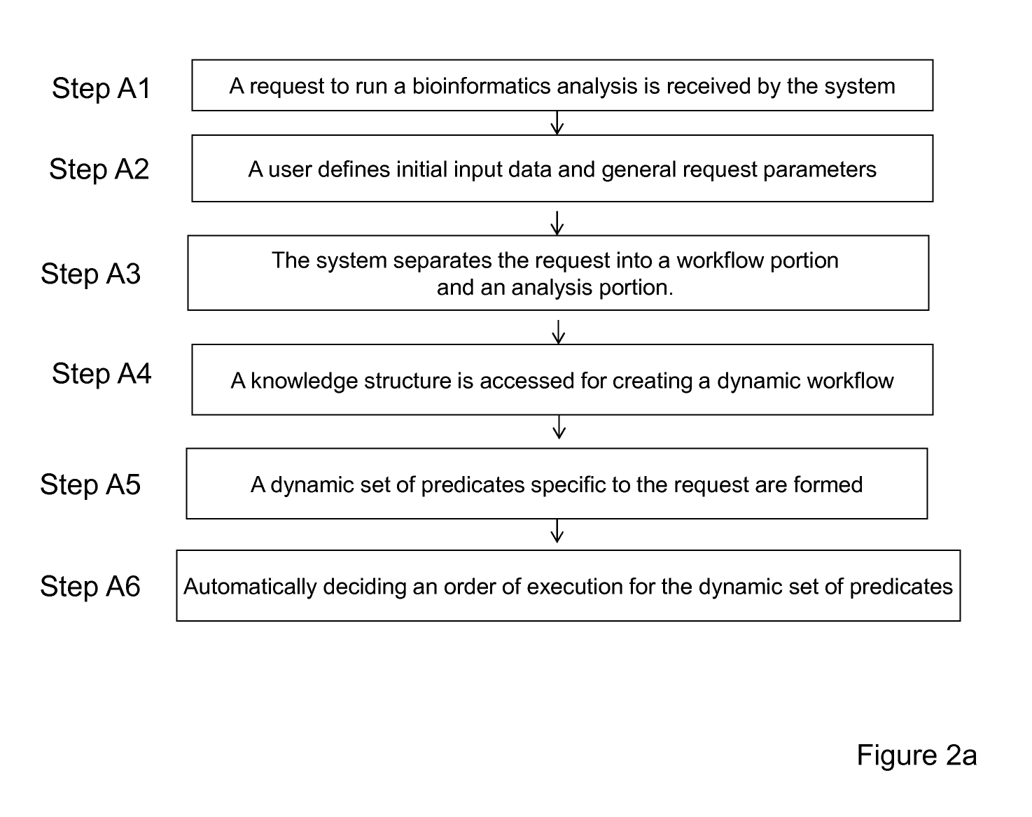

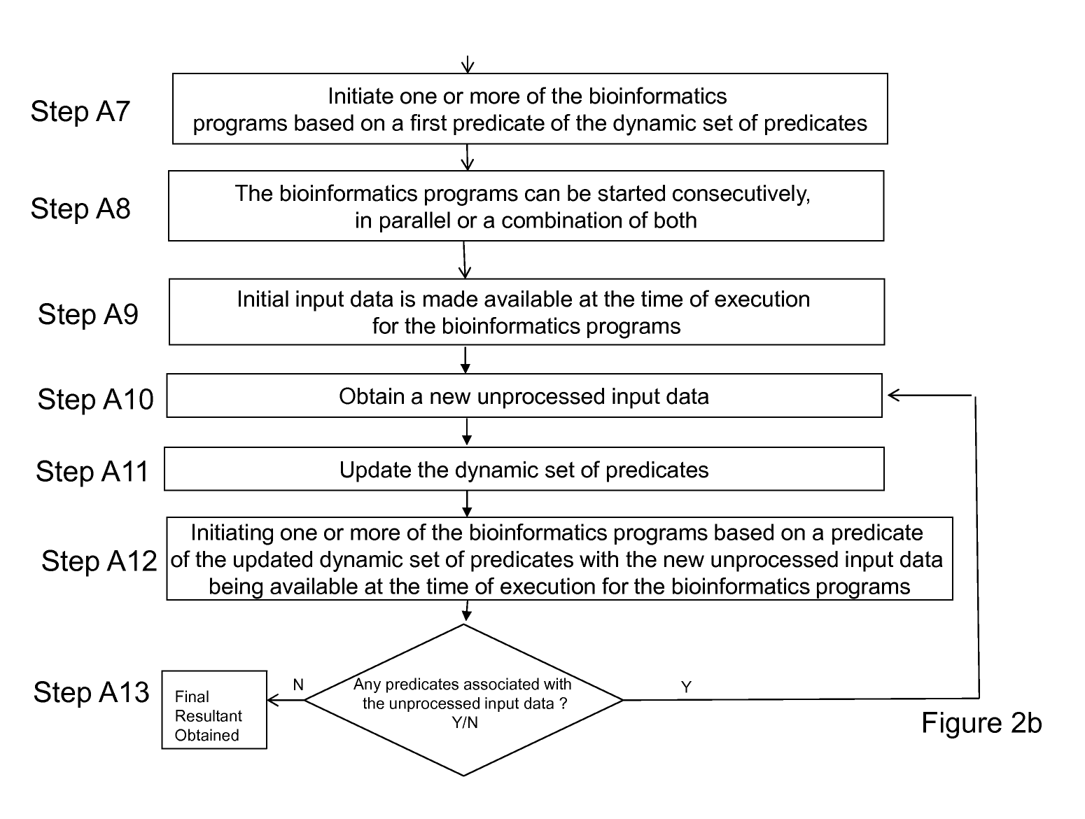

In use, as shown in FIG. 2a-b, a request to run a bioinformatics analysis is received by the system. (Step A1) The request is formulated by a user and can define initial input data and general request parameters. (Step A2). The general request parameters include a desired set of methods and available resources needed to obtain the resultant for the bioinformatics analysis.

Once received, the disclosed technology separates the request into a workflow portion and an analysis portion. (Step A3). Using the workflow portion, a knowledge structure is accessed for creating a dynamic workflow. (Step A4). The knowledge structure can include a plurality of predicates describing computational relationships between bioinformatics data files and bioinformatics programs. The workflow portion forms a dynamic set of predicates specific to the request based upon a source of the initial input data, the general request parameters and the plurality of predicates of the knowledge structure. (Step A5). The disclosed technology automatically decides an order of execution for the dynamic set of predicates based upon the desired set of methods and the available resources defined in the general request parameters. (Step A6).

The analysis portion then uses the dynamic set of predicates to initiate one or more of the bioinformatics programs based on a first predicate of the dynamic set of predicates. (Step A7). The bioinformatics programs can be started consecutively, in parallel or a combination of both. (Step A8). The initial input data is made available at the time of execution for the bioinformatics programs. (Step A9). After the program is complete, a new unprocessed input data is obtained from an output of the program. (Step A10).

The workflow portion then updates the dynamic set of predicates based upon the new unprocessed input data, the general request parameters and the plurality of predicates of the knowledge structure. (Step A11).

Once again, one or more of the bioinformatics programs are initiated based on a next predicate of the dynamic set of predicates with the new unprocessed input data being available at the time of execution for the bioinformatics programs. (Step A12). This process repeats until no more predicates can be associated with the unprocessed input data or no more unprocessed data can be obtained. The order of execution for the dynamic set of predicates can change during an execution process based on intermediate results. The execution process continues until the programs and data reaches a state of equilibrium. In other words, every time a predicate is complete and another input is found, a new predicate is obtained for the input, parameters for an application are set and, when a CPU becomes available for the task, the application is started. A final resultant is obtained for the bioinformatics analysis. (Step A13).

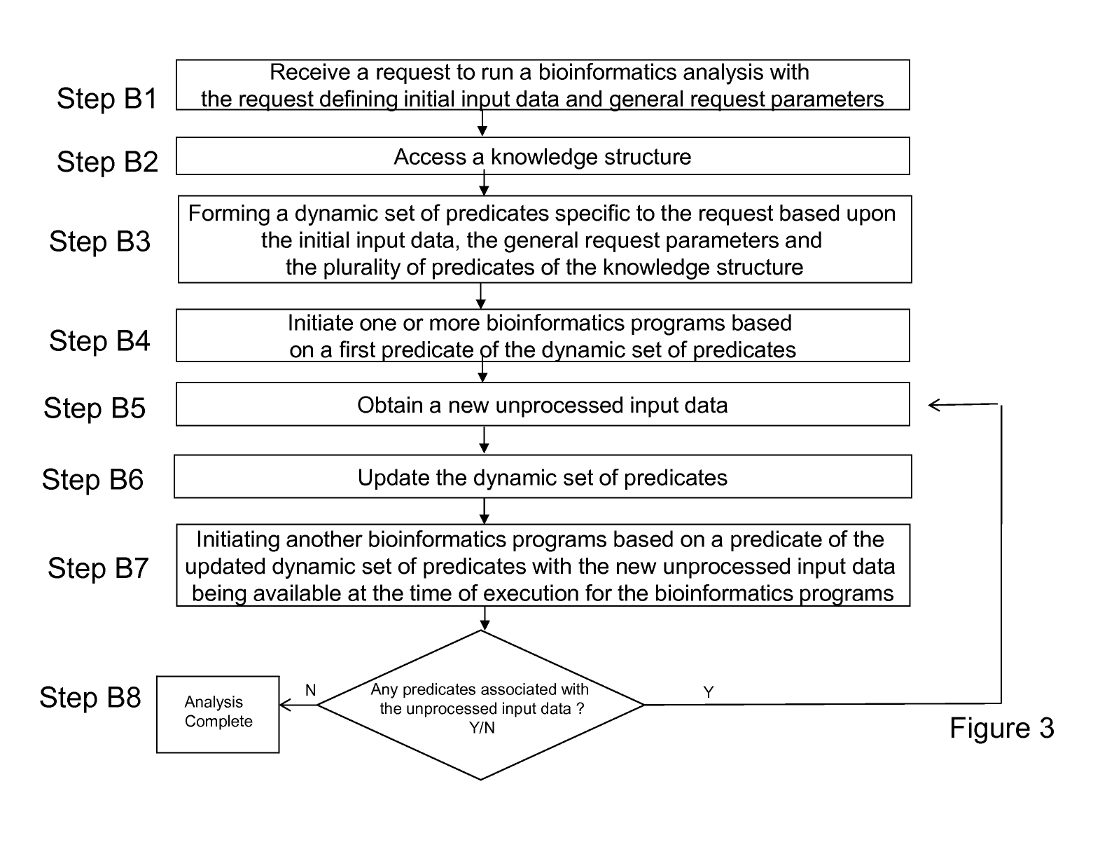

In one implementation, as shown in FIG. 3, the system can receive a request to run a bioinformatics analysis with the request defining a source of initial input data and general request parameters. (Step B1). Once received, a knowledge structure can be accessed. (Step B2). The knowledge structure can include a plurality of predicates describing computational relationships, e.g., “program X takes raw NGS reads in FASTQ format as input”, “program Y produces results in BAM format”, “program X takes input data in VCF format”, etc.), between bioinformatics data files and bioinformatics programs. A dynamic set of predicates specific to the request is formed based upon the initial input data, the general request parameters and the plurality of predicates of the knowledge structure. (Step B3). One or more bioinformatics programs are initiated based on a first predicate of the dynamic set of predicates. (Step B4). The initial input data can be made available at the time of execution for the bioinformatics programs. A new unprocessed input data is obtained from an output of the bioinformatics program. (Step B5). Based on the new unprocessed input data, the dynamic set of predicates can be updated. (Step B6). Another bioinformatics programs can be initiated based on a next predicate of the dynamic set of predicates with the new unprocessed input data being available at the time of execution for the bioinformatics programs. (Step B7). These steps are repeated until no more predicates can be associated with the unprocessed input data or no more unprocessed data can be obtained. If no more, the analysis is complete. (Step B8).

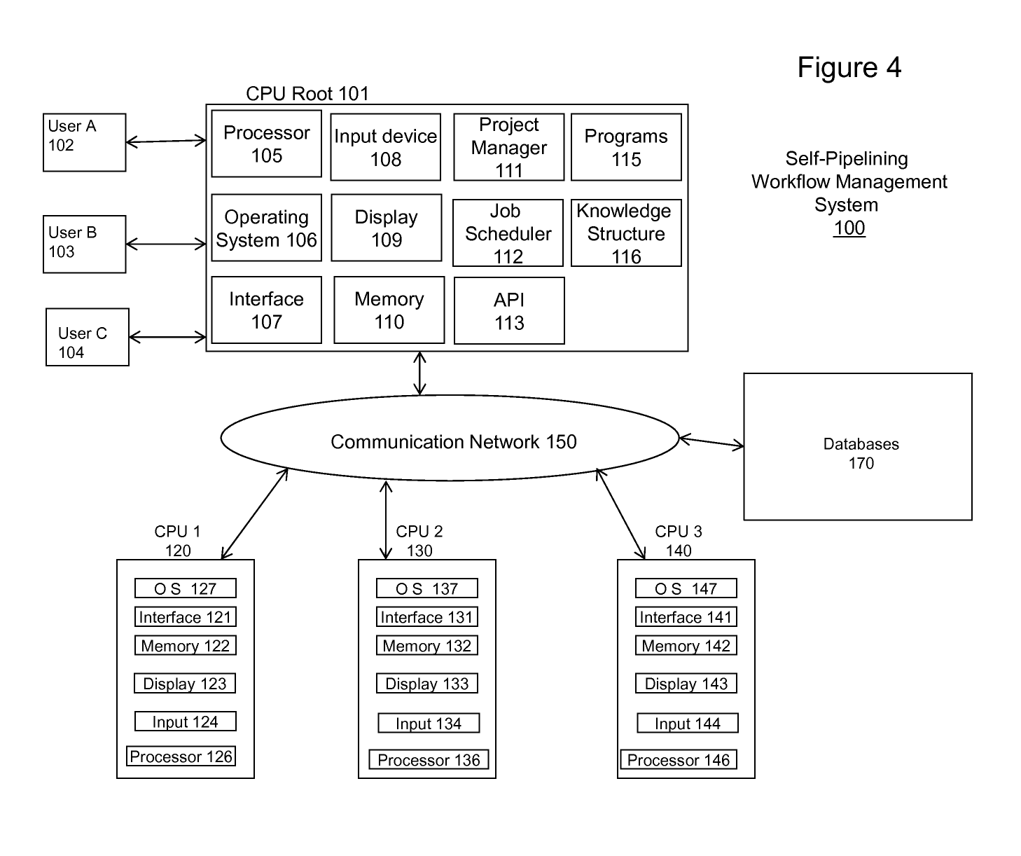

FIG. 4 is a schematic diagram of an example of an intelligent resource management system 100. The system 100 includes one or more processors 105, 126, 136, 146, one or more display devices 109, 123, 133, 143, e.g., CRT, LCD, one or more interfaces 107, 121, 131, 141, input devices 108,124, 134, 144, e.g., touchscreen, keyboard, mouse, scanner, etc., and one or more computer-readable mediums 110, 122, 132, 142, 170. These components exchange communications and data using one or more buses, e.g., EISA, PCI, PCI Express, etc. The term “computer-readable medium” refers to any non-transitory medium that participates in providing instructions to processors 105, 126, 136, 146 for execution. The computer-readable mediums further include operating systems 106, 127, 137, 147.

The operating systems 106, 127, 137, 147 can be multi-user, multiprocessing, multitasking, multithreading, real-time, near real-time and the like. The operating systems 106, 127, 137, 147 can perform basic tasks, including but not limited to: recognizing input from input devices 108, 124, 134, 144; sending output to display devices 109, 123, 133, 143; keeping track of files and directories on computer-readable mediums 110, 122, 132, 142, e.g., memory or a storage device; controlling peripheral devices, e.g., disk drives, printers, etc.; and managing traffic on the one or more buses 151-157. The operating systems 106, 127, 137, 147 can also run algorithms 114 associated with the system 100 and accessing the knowledge structure 115.

The network communications code can include various components for establishing and maintaining network connections, e.g., software for implementing communication protocols, e.g., TCP/IP, HTTP, Ethernet, etc.

Moreover, as can be appreciated, in some implementations, the system 100 of FIG. 4 is split into a root-slave environment 101, 120, 130, 140 communicatively connected with connectors 154-157, where one or more root computers 101 include hardware as shown in FIG. 4 and also code for managing the resources of the computer network and where one or more slave computers 120, 130, 140 include hardware as shown in FIG. 4.

Implementations of the subject matter and the operations described in this specification can be done in electronic circuitry, or in computer software, firmware, or hardware, including the structures disclosed in this specification and their structural equivalents, or in combinations of one or more of them. Implementations of the subject matter described in this specification can be done as one or more computer programs, e.g., one or more modules of computer program instructions, encoded on a computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be, or can be included in, a computer-readable storage device, a computer-readable storage substrate, a random or serial access memory array or device, or a combination of one or more of them.

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or combinations of them. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, e.g., a virtual machine, or a combination of one or more of them. The apparatus and execution environment can realize various different computing model infrastructures, e.g., web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program can, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor can receive instructions and data from a read-only memory or a random access memory or both. The elements of a computer comprise a processor for performing or executing instructions and one or more memory devices for storing instructions and data. Generally, a computer can also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto- optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, thought or tactile input. In addition, a computer can interact with a user by sending documents to and receiving documents from a device that is used by the user.

While this specification contains many specific implementation details, these should not be construed as limitations on the scope of the disclosed technology or of what can be claimed, but rather as descriptions of features specific to particular implementations of the disclosed technology. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. In some cases, the actions recited in the claims can be performed in a different order and still achieve desirable results. Moreover, the separation of various system components in the implementations described above should not be understood as requiring such separation in all implementations, and it should be understood that the described program components and systems can generally be integrated together in a single software product or packaged into multiple software products.

The foregoing Detailed Description is to be understood as being in every respect illustrative, but not restrictive, and the scope of the disclosed technology disclosed herein is not to be determined from the Detailed Description, but rather from the claims as interpreted according to the full breadth permitted by the patent laws. It is to be understood that the implementations shown and described herein are only illustrative of the principles of the disclosed technology and that various modifications can be implemented without departing from the scope and spirit of the disclosed technology.

1. A method comprising the steps of:
a) receiving a request to run a bioinformatics analysis, the request defining a source for initial input data and general request parameters;
b) accessing a knowledge structure stored in a database, the knowledge structure including a plurality of predicates describing computational relationships between at least one bioinformatics data file and at least two bioinformatics programs;
c) forming a dynamic set of predicates specific to the request based upon the initial input data, the general request parameters and the plurality of predicates of the knowledge structure;
d) initiating at least one of the at least two bioinformatics programs based on a first predicate of the dynamic set of predicates, the initial input data being available at the time of execution for the at least one of the at least two bioinformatics programs;
e) obtaining a new unprocessed input data from the at least one of the at least two bioinformatics programs;
f) updating the dynamic set of predicates based upon the upon the new unprocessed input data, the general request parameters and the plurality of predicates of the knowledge structure;
g) initiating at least one more of the at least two bioinformatics programs based on a predicate of the updated set of predicates, the new unprocessed input data being available at the time of execution for the at least one more of the at least two bioinformatics programs; and
h) repeating the method from step e) until no more predicates can be associated with the unprocessed input data or no more unprocessed data can be obtained.

2. The method of claim 1 further comprising the steps of:
obtaining a resultant for the bioinformatics analysis.

3. The method of claim 2 wherein the general request parameters includes a desired set of methods and available resources needed to obtain the resultant for the bioinformatics analysis.

4. The method of claim 3 further comprising the steps of:
automatically deciding an order of execution for the dynamic set of predicates based upon the desired set of methods and the available resources defined in the general request parameters.

5. The method of claim 4 wherein the order of execution for the dynamic set of predicates can change dynamically during an execution process based on intermediate results.

6. The method of claim 4 further comprising the steps of:
building a mapping table based upon the order of execution for the dynamic set of predicates needed to fulfill the request, the mapping table guiding starts and stops of the bioinformatics programs.

7. The method of claim 1 wherein the bioinformatics programs are started consecutively, in parallel or a combination of both.

8. The method of claim 5 wherein the execution process continues until the programs and data reaches a state of equilibrium.

9. A system comprising:
one or more processors;
one or more computer-readable storage mediums containing instructions configured to cause the one or more processors to perform operations including:
a) receiving a request to run a bioinformatics analysis, the request defining a source for initial input data and general request parameters;
b) accessing a knowledge structure stored in a database, the knowledge structure including a plurality of predicates describing computational relationships between at least one bioinformatics data file and at least two bioinformatics programs;
c) forming a dynamic set of predicates specific to the request based upon the initial input data, the general request parameters and the plurality of predicates of the knowledge structure;
d) initiating at least one of the at least two bioinformatics programs based on a first predicate of the dynamic set of predicates, the initial input data being available at the time of execution for the at least one of the at least two bioinformatics programs;
e) obtaining a new unprocessed input data from the at least one of the at least two bioinformatics programs;
f) updating the dynamic set of predicates based upon the upon the new unprocessed input data, the general request parameters and the plurality of predicates of the knowledge structure;
g) initiating at least one more of the at least two bioinformatics programs based on a predicate of the updated set of predicates, the new unprocessed input data being available at the time of execution for the at least one more of the at least two bioinformatics programs; and
h) repeating the method from step e) until no more predicates can be associated with the unprocessed input data or no more unprocessed data can be obtained.

10. The system of claim 9 further performing the operation of:
obtaining a resultant for the bioinformatics analysis.

11. The system of claim 10 wherein the general request parameters includes a desired set of methods and available resources needed to obtain the resultant for the bioinformatics analysis.

12. The system of claim 11 further performing the operation of:
automatically deciding an order of execution for the dynamic set of predicates based upon the desired set of methods and the available resources defined in the general request parameters.

13. The system of claim 12 wherein the order of execution for the dynamic set of predicates can change dynamically during an execution process based on intermediate results.

14. The system of claim 12 further performing the operation of:
building a mapping table based upon the order of execution for the dynamic set of predicates needed to fulfill the request, the mapping table guiding starts and stops of the bioinformatics programs.

15. The system of claim 9 wherein the bioinformatics programs are started consecutively, in parallel or a combination of both.

16. The system of claim 13 wherein the execution process continues until the programs and data reaches a state of equilibrium.

17. A computer-program product, the product tangibly embodied in a machine-readable storage medium, including instructions configured to cause a data processing apparatus to:
a) receive a request to run a bioinformatics analysis, the request defining a source for initial input data and general request parameters;
b) access a knowledge structure stored in a database, the knowledge structure including a plurality of predicates describing computational relationships between at least one bioinformatics data file and at least two bioinformatics programs;
c) form a dynamic set of predicates specific to the request based upon the initial input data, the general request parameters and the plurality of predicates of the knowledge structure;
d) initiate at least one of the at least two bioinformatics programs based on a first predicate of the dynamic set of predicates, the initial input data being available at the time of execution for the at least one of the at least two bioinformatics programs;
e) obtain a new unprocessed input data from the at least one of the at least two bioinformatics programs;
f) update the dynamic set of predicates based upon the upon the new unprocessed input data, the general request parameters and the plurality of predicates of the knowledge structure;
g) initiate at least one more of the at least two bioinformatics programs based on a predicate of the updated set of predicates, the new unprocessed input data being available at the time of execution for the at least one more of the at least two bioinformatics programs; and
h) repeat the method from step e) until no more predicates can be associated with the unprocessed input data or no more unprocessed data can be obtained.

18. The product of claim 17 further including instructions configured to cause a data processing apparatus to:
obtain a resultant for the bioinformatics analysis.

19. The product of claim 17 wherein the bioinformatics programs are started consecutively, in parallel or a combination of both.

20. The product of claim 17 wherein the execution continues until the programs and data reaches a state of equilibrium.
